(19) United States
(12) Patent Application Publication
(10) Pub. No.: US 2024/0100626 A1
(43) Pub. Date: Mar. 28, 2024

(54) LASER WORKING SYSTEM FOR PERFORMING A WORKING PROCESS ON A WORKPIECE BY MEANS OF A LASER BEAM AND METHOD FOR MONITORING A WORKING PROCESS ON A WORKPIECE BY MEANS OF A LASER BEAM

(71) Applicant: Precitec GmbH & Co. KG, Gaggenau (DE)

(72) Inventor: Joachim Schwarz, Kleinandelfingen (CH)

(21) Appl. No.: 17/767,642

(22) PCT Filed: Oct. 5, 2020
(86) PCT No.: PCT/EP2020/077780

§ 371 Date: Apr. 8, 2022

(30) Foreign Application Priority Data
Oct. 10, 2019 (DE) 102019127323.4

(51) Int. Cl. B23K 26/03; G06T 7/00; G06V 10/143; G06V 10/147; G06V 10/82; G06V 20/10; G06V 20/52

(52) U.S. Cl. CPC B23K 26/032; G06T 7/0004; G06V 10/143; G06V 10/147; G06V 10/82; G06V 20/194; G06V 20/52; G06T 2207/20081; G06T 2207/20084; G06T 2207/30164

(57) ABSTRACT

A laser working system for performing a working process on a workpiece with a laser beam includes: a laser working head for radiating a laser beam into a working region on the workpiece; and a sensor unit for monitoring the working process, the sensor unit having at least one hyperspectral sensor. The sensor unit is designed to capture a hyperspectral image of a region of the workpiece, the hyperspectral image having N times M pixels. The hyperspectral image has two spatial dimensions x and y and a spectral dimension λ. N indicates the number of pixels in the first spatial dimension x, M indicates the number of pixels in the second spatial dimension y, and L indicates the number of spectral bands in the spectral dimension λ. M, N and L are natural numbers. A method for monitoring a working process is also provided.

### CROSS-REFERENCE TO RELATED APPLICATIONS

This application is the U.S. National Stage of PCT/EP2020/077780 filed on Oct. 5, 2020, which claims priority to German Patent Application 102019127323.4 filed on Oct. 10, 2019, the entire content of both are incorporated herein by reference in their entirety.

### FIELD OF THE INVENTION

The present disclosure relates to a laser working system for performing a working process on a workpiece, in particular on a metal workpiece, using a laser beam and a method for monitoring a working process on a workpiece, in particular on a metal workpiece, using a laser beam. In particular, the present disclosure relates to a laser working system including a sensor unit that is configured to capture a hyperspectral image of a region of the workpiece, and a method wherein a hyperspectral image of an region of a workpiece is captured.

### BACKGROUND OF THE INVENTION

In a laser working system for machine working a workpiece using a laser beam, the laser beam emerging from a laser light source or from one end of a laser optical fiber is focused or collimated onto the workpiece to be machine worked with the aid of beam guiding and focusing optics. Working may include laser cutting, soldering or welding, for example. The laser working system may include a laser working device, for example a laser working head, such as a laser cutting head or a laser welding head. In particular when laser welding or soldering a workpiece, it is important to monitor the welding or soldering process in order to be able to assess and ensure the quality of the work. This includes the detection and classification of working defects. Current solutions for process monitoring and quality assessment include so-called “pre-process”, “in-process” and “post-process” inspection or monitoring.

Pre-process monitoring has the task of detecting a joining gap between two joining partners or workpieces in order to guide the laser beam to the appropriate position and to determine the offset of the joining partners. In most cases, triangulation systems are used for this purpose.

The post-process inspection is used in particular for process monitoring and quality assessment, for example to identify working errors. The aim of post-process inspection is to reliably locate and detect any defects or working errors. The post-process inspection of welded or soldered seams is typically performed using image processing in which 2D images showing the welded or soldered seams on the surface of a machine worked workpiece are analyzed. For example, in the case of laser welding, the resulting weld seam may be inspected and measured or analyzed in accordance with applicable standards (e.g. SEL100). On the basis of the recorded images, features which represent or describe the working quality, in particular the quality of the welded and soldered seams, are then extracted and classified. Based on the extracted and classified features, working errors such as holes or pores in the workpiece surface are recognized and classified and the machine worked workpiece is marked or classified as “good” (i.e. suitable for further working or sale) or “poor” (i.e. as rejects). Which significant features can be used for evaluating the quality of the laser working at all and what influence these features then have on the evaluation of the quality can only be decided and established by experts in the field since the complexity of these systems is very high due to the number of parameters to be set being high. In current systems, up to 300 parameters are set (so-called “parameterization”). The use of post-process inspection for quality assessment and classification increases the cost, integration effort and maintenance effort of the laser working systems.

The in-process inspection or monitoring is typically used for the continuous monitoring of a laser working process and is performed while the laser working process is being carried out. During the monitoring, measurement signals of various measurement variables of the laser working process are acquired and assessed, in particular radiation emitted or reflected by the workpiece while the working process is being carried out, for example plasma radiation, backscattered laser power and thermal radiation. Typically, during laser working, radiation in the visible range between 400 nm and 850 nm is emitted by the melt pool, in the range between 400 nm and 1100 nm by the resulting plasma, in the range of 900 nm to 1100 nm light backscattered by the laser and in the range greater than 1000 nm thermal radiation are emitted or reflected. Thus, radiation is emitted or reflected in a wide range between 400 nm and 1800 nm. Normally, during in-process monitoring, the signals are recorded or processed without spatial resolution and/or without wavelength resolution. Existing solutions for in-process monitoring use diodes that detect the emitted or reflected radiation in narrow-band wavelength ranges and output it as a measurement signal. For example, a Si diode for detection in the range between 400 nm and 800 nm, an InGaAs diode for detection in the range between 800 nm and 1200 nm and another InGaAs or Ger diode for detection in the range between 1200 nm and 2000 nm are used. Depending on the process, ranges may also be selected from these wavelength ranges with appropriate optical filters. For example, depending on the type of laser used, the wavelength range between 1020 nm and 1090 nm is filtered or attenuated. Wavelength ranges outside the detection ranges of the diodes and the optical filters are not detected. With diodes, a location-dependent representation of the intensities is also not possible.

The intensity curves recorded with the diodes are filtered and checked for exceeding threshold values. The filter parameters and threshold values are set separately for each wavelength range. The detection and evaluation of individual wavelength ranges is thus independent of the other wavelength ranges. Conclusions about certain types of defects such as a gap between the components to be joined, a lack of welding penetration, defective welding, the formation of pores or an offset of the weld with respect to the joint edge cannot be reliably drawn with a separate assessment or classification of the intensity curves in defined wavelength ranges.

A closed-loop control of the laser working process based on the individually recorded and evaluated wavelength ranges usually cannot be implemented either since the relationships between the individual measurement signals and the control variables or working parameters of the laser working process are not sufficiently known. In particular, the dependencies of the control variables on the detected signals are not unambiguous. In other words, the relationship between the control variables of the laser working process, such as the focus position, the distance and position of the laser working head from the joint, the feed rate, the laser power and gas supply amount, possibly also the wire feed speed and the measurement signals are not clearly known or apparent. Also, complete information about the state of the laser working process may not be included in the measurement signals. It is therefore not possible to performed closed-loop control of the laser welding process.

Other solutions use spatially resolving sensors and image processing to measure the melt pool and keyhole geometry, thereby facilitating quality assessment. DE10 2011 078 276 B3 describes a method wherein brightness profiles of the workpiece surface are acquired using CMOS sensors in the range between 450 nm and 800 nm. These profiles are compared with models in order to draw conclusions about the working quality.

Other systems use image sensors to provide spatially resolved images of a joint gap, the working region itself and the weld bead. However, the CMOS sensors used integrate the detected illumination intensity over a large wavelength range, thereby limiting the ability to provide information about the working process and therefore also making it impossible to perform closed loop control of the working process. An additional problem is the complex parameterization of these systems.

### SUMMARY OF THE INVENTION

It is therefore an object of the invention to simplify monitoring and closed-loop control of a laser working process and the detection and classification of working errors.

Furthermore, it is an object of the invention to facilitate the detection and classification of working errors and the monitoring and closed-loop control of a laser working process based on detected emitted process radiation and/or reflected laser radiation.

Furthermore, it is an object of the invention to facilitate the spatially resolved and wavelength-resolved detection of emitted process radiation and/or reflected laser radiation of the laser working process.

Furthermore, it is an object of the invention to identify and classify working errors reliably and quickly and without complex parameterization processes. It is also an object of the invention to detect working errors during an ongoing laser working process, preferably in real time and in an automated manner.

These objects are achieved by the subject matter disclosed herein. Advantageous embodiments and further developments are also disclosed.

The invention is based on the idea of carrying out the monitoring of a laser working process, in particular a laser welding or laser cutting process, using a hyperspectral sensor, in particular a hyperspectral camera. In other words, during a laser working process, at least one hyperspectral sensor captures, preferably continuously, hyperspectral images of a region of a workpiece. The captured hyperspectral images comprise, in each pixel, a spectrum over a broad wavelength range of radiation emitted or reflected by the workpiece during working, which can be referred to as “outgoing radiation” for short. The outgoing radiation may include, in particular, emitted process radiation, for example thermal radiation and plasma radiation, and reflected light from the laser beam. The captured hyperspectral images fully describe or characterize the laser working process. The hyperspectral images may be used as input data for image processing by a deep neural network which, based thereon, calculates continuously, preferably in real time, an output vector containing information about the working process, for example information about a state of the laser working process or about a working result or about a working error at the workpiece. For example, the output vector may be used to evaluate the quality of the working process, in particular to assess laser welding seams and soldered seams. The output vector may also be used to perform closed-loop control of the laser working process.

Thus, the use of a hyperspectral sensor, such as a hyperspectral camera, simplifies the acquisition of images of a region of the workpiece in different wavelength bands or spectral bands. The spatially resolved and spectrally resolved or wavelength-resolved detection of radiation in a region of the workpiece thus allows for precise data detection for the monitoring and closed-loop control of the working process. The use of a large number of diodes, beam splitters and/or filters or complex filter cascades can thus be avoided. The hyperspectral images may be used as so-called snapshot recordings, with all data of a hyperspectral image being recorded simultaneously. Alternatively, the hyperspectral images may be captured in a so-called push-broom method, wherein, for example, all pixel rows of the hyperspectral sensor are recorded simultaneously in a different wavelength band and the hyperspectral sensor and the workpiece region are then shifted relative to one another in the y-direction or row direction of the sensor pixels, so that the pixel rows are successively recorded in all wavelength bands. In this case, the pixels of a pixel row are arranged along a first direction, also referred to as the x-direction or column direction.

According to a first aspect of the present disclosure, a laser working system for performing a working process on a workpiece using a laser beam is provided, said laser working system comprising: a laser working head for radiating the laser beam into a working region on the workpiece; and a sensor unit for monitoring the working process with at least one hyperspectral sensor, the sensor unit being configured to capture a hyperspectral image having N times M pixels of a region of the workpiece, each of which includes L different values in a spectral dimension, wherein the hyperspectral image has two spatial dimensions x and y and the spectral dimension λ. and where N denotes a number of pixels in the first spatial dimension x, M denotes a number of pixels in the second spatial dimension y, and L denotes the number of spectral bands in the spectral dimension λ, of the hyperspectral image, where M, N and L are natural numbers.

According to a second aspect of the present disclosure, a method for monitoring a working process on a workpiece using a laser beam is specified, said method comprising the steps of: radiating the laser beam into a working region on the workpiece, capturing a hyperspectral image with N times M pixels of a region of the workpiece, each pixel comprising L different values in a spectral dimension k, wherein the hyperspectral image has two spatial dimensions x and y and the spectral dimension k, and where N is a number of pixels in the first spatial dimension x, M a number of pixels in the second spatial dimension y, and L the number of spectral bands in the spectral dimension λ, of the hyperspectral image, where M, N and L are natural numbers.

The region of the workpiece captured in the hyperspectral image may include at least one of the following regions on the workpiece: the current working region of the laser working process, a region in advance of the laser beam, a region trailing the laser beam, a region yet to be machine worked and a machine worked region. The current working region denotes a region of the workpiece into which the laser beam is radiated. Particularly in the case of laser welding, the region of the workpiece that is captured may include at least one of the following regions: a vapor capillary, a melt pool, a solidified melt, a joint edge between two workpieces to be welded together, and a seam bead. The hyperspectral sensor may be aimed at the region of the workpiece to be captured in the hyperspectral image. Depending on which regions are contained in the captured workpiece region, the hyperspectral image may be used for pre-process, in-process and/or post-process monitoring.

Thus, the laser working system comprises a sensor unit configured to capture and output a hyperspectral image of a region of a workpiece. The sensor unit may be configured to capture radiation emanating from the region of the workpiece, for example emitted process radiation and/or reflected or backscattered radiation, in particular reflected or backscattered laser radiation, and to output it as a hyperspectral image. In particular, the sensor unit may be configured to capture at least one of the following types of radiation: thermal radiation, radiation in the infrared range of light, radiation in the near infrared range of light, radiation in the visible range of light, plasma radiation, reflected or backscattered light of the (working) laser beam, and light radiated by a light source and then reflected, such as radiated and reflected measuring light of a coherence tomograph.

The hyperspectral image includes a plurality of pixels. In particular, the hyperspectral image comprises N times M pixels, wherein the hyperspectral image has two spatial dimensions x and y and one spectral dimension k, where N indicates a number of pixels in the first spatial dimension x and M indicates a number of pixels in the second spatial dimension y. Each of the pixels comprises L values in the spectral dimension λ, where L indicates a number of spectral bands in the spectral dimension λ, of the hyperspectral image. The first spatial dimension x and the second spatial dimension y may correspond to two Cartesian directions of the region of the workpiece. Thus, each of the N times M pixels may correspond to a point in the captured region of the workpiece. Each of the L values of a pixel corresponds to a detected radiation intensity, “intensity” for short, of the radiation emanating from the corresponding point of the captured region of the workpiece in the respective spectral band. The hyperspectral image may thus indicate a spectral distribution within the wavelength range covered by the spectral bands of the radiation emanating from the detected region of the workpiece. The captured hyperspectral image therefore preferably corresponds to an image of the workpiece region that is both spatially resolved and wavelength-resolved. The sensor unit may thus replace a plurality of individual sensors or an array of individual sensors, in particular a plurality of diodes, according to the prior art.

The hyperspectral image may also be referred to as a hyperspectral cube. The hyperspectral image may also be considered as L individual images, each of the individual images having a resolution of N times M pixels and corresponding to a detected intensity of the radiation emanating from the region of the workpiece in one of the L spectral bands. In particular, this may be the case for a so-called mosaic sensor. When using the push-broom method with a hyperspectral sensor, in which L different filters for the L different wavelength bands are arranged on the pixel rows of the hyperspectral sensor, the hyperspectral image may be considered as M individual images, wherein each of the individual images has a resolution of N times L and each of the L rows of a individual image corresponds to a detected intensity of radiation emanating from the corresponding row of the region of the workpiece in the respective one of the L spectral bands. The hyperspectral image may also be referred to as a hyperspectral cube, with the hyperspectral cube having N times M times L or N times L times M elements or values. The data output from the sensor unit may be in the form of a 3D data cube with two spatial dimensions and one spectral dimension. The hyperspectral cube may also be referred to as a hyperspectral data cube or, analogously to a 3-channel RGB image, as an L-channel hyperspectral image.

The number of spectral bands L may be 16 or more, preferably 20 or more, preferably 25 or more, particularly preferably 100 or more.

The spectral bands in the spectral dimension λ, may be of the same size and/or uniformly distributed over a wavelength range of the detected radiation and/or adjacent to one another and/or consecutive. The spectral bands preferably do not overlap.

In order to enable continuous monitoring of the laser working process, the sensor unit may be configured to capture hyperspectral images continuously or to capture one hyperspectral image per predefined time interval.

The sensor unit may be configured to acquire all L values for all of the N times M pixels of the hyperspectral image substantially simultaneously. In this case, the hyperspectral image may be captured as a snapshot, the intensities in all spectral bands being captured simultaneously for all pixels. Therefore, the captured hyperspectral image preferably corresponds to an image of the workpiece region that is both spatially resolved and wavelength-resolved at a specific point in time. In other words, the intensity of the radiation may be detected simultaneously in all spectral bands and for the entire captured region of the workpiece. This allows the laser working process to be monitored precisely.

The hyperspectral sensor may comprise a mosaic filter with L different optical bandpass filters. Each optical bandpass filter may have a passband corresponding to one of the spectral bands in the spectral dimension λ. 4×4 or 5×5 optical mosaic filters may be arranged on the pixels of the hyperspectral sensor, with each individual bandpass filter of the mosaic filter being arranged on a corresponding pixel. Accordingly, each pixel of the hyperspectral sensor detects an intensity of the outgoing radiation filtered by the respective bandpass filter. Thus, in the case of the hyperspectral sensor with a 4×4 mosaic filter, 16 bandpass-filtered images are generated, and in the case of the hyperspectral sensor with a 5×5 mosaic sensor, 25 bandpass-filtered images of the hyperspectral image are generated.

Alternatively, the hyperspectral sensor may include a row-based filter with L different optical bandpass filters. Each optical bandpass filter may have a passband corresponding to one of the spectral bands in the spectral dimension λ. The L different optical bandpass filters may be arranged on the pixel rows of the hyperspectral sensor. The pixels of a pixel row are arranged in a first direction, also referred to as the x-direction or column direction. For example, each bandpass filter may be arranged over at least one row and the L different optical bandpass filters are arranged in sequence in a second direction, also referred to as y-direction or row direction. The first direction is perpendicular to the second direction. Each of the L optical bandpass filters may correspond to one row or n rows of pixels (n>1). The L different optical bandpass filters are thus preferably arranged in such a way that the transmission or the transmission range changes after each row or after n rows. Accordingly, each row or each n rows of the hyperspectral sensor capture(s) an intensity of the outgoing radiation filtered by the respective bandpass filter. Thus, a discrete spectrum of the outgoing radiation can be recorded. This method is also known as the “push broom” method and may be used in laser working systems with high-precision material feed. The synchronization of the row readout may be coordinated with the material feed speed so that each region of the surface of the workpiece is captured multiple times, i.e. at different times with each of the different bandpass filters. This method allows the number of bandpass filters to be increased.

The at least one hyperspectral sensor may include a hyperspectral camera. In particular, the at least one hyperspectral sensor may include a CMOS camera, an infrared enhanced CMOS sensor, a near-infrared (NIR) enhanced CMOS sensor, an InGaAs-based sensor, a sensor array and/or a diode array.

The at least one hyperspectral sensor may have a spectral sensitivity range from 400 nm to 1800 nm and/or from 400 nm to 950 nm and/or from 400 nm to 1000 nm and/or from 1000 nm to 1700 nm and/or from 950 nm to 1800 nm and/or from 1200 nm to 2000 nm.

In particular, the sensor unit may include at least two hyperspectral sensors with different sensitivity ranges. The sensor unit may be configured to convert and output the data sensed by the respective hyperspectral sensors into a hyperspectral image with N times M pixels, each of the pixels comprising L values in the spectral dimension.

The sensor unit may include at least one beam splitter configured to split the radiation emanating from the region of the workpiece onto the at least two hyperspectral sensors.

The sensor unit may be coupled, in particular detachably coupled, to the laser working head. The sensor unit may be arranged on an outside, in particular on a side surface, of the laser working head. An optical axis of the sensor unit may at least partially extend in parallel and/or coaxially with the propagation direction of the laser beam.

The laser working system may also include a computing unit configured to determine an input tensor based on the hyperspectral image and to determine an output tensor based on the input tensor by means of a transfer function containing information about the working process, wherein the transfer function between the input tensor and the output tensor is formed by a deep neural network, in particular by a deep convolutional neural network. The computing unit may be configured to form the output tensor in real time and/or to output control data to a control unit of the laser working system based on the output tensor.

The method may further comprise the steps of: determining, based on the hyperspectral image, an input tensor, and determining, based on the input tensor and by means of a transfer function, an output tensor containing information about the working process, wherein the transfer function between the input tensor and the output tensor is formed by a trained neural network, for example by a deep neural network or by a deep convolutional neural network. The output tensor may be formed in real time.

The information about the working process may include information about a working error and/or a working region of the workpiece. In particular, the output tensor may contain one of the following information: information about a joining gap, information about an offset between joining partners, information about a melt pool, information about a vapor capillary, information about a welding bead, information about a state of the working process, information about a working error, presence of at least one working error, type of the working error, position of the working error on the workpiece, probability of a working error of a specific type and spatial and/or areal extent of the working error.

Accordingly, the captured hyperspectral images may serve as a basis for the detection and classification of working errors. The working errors may be classified in particular as follows: gap, offset, lack of welding penetration, lack of welding, ejections, pore formation. The hyperspectral images may also be used to detect a deviation or anomaly in the laser working process. An anomaly is, for example, a deviation from a weld that was previously marked or classified as “good”.

In order to train a monitored machine learning method, e.g. a neural network, both a large number of working processes free of errors, for example weldings, and a large number of working processes including errors are carried out and hyperspectral images are captured in each case. The training data may be used for anomaly detection, in particular when few weldings with errors can be produced. The training of the neural networks may be performed using standard methods.

The closed-loop control or optimization of working processes may be facilitated by means of so-called “reinforcement learning” of the neural network. In the reinforcement learning method, control actions of the working process, such as changing the laser power or changing the welding speed, are evaluated as to whether they result in a process or process flow that is considered optimal, for example a process without working errors. The actions that result in an optimal process are highly rated. In this case, a large number of working processes are carried out with a corresponding capture of hyperspectral images, the hyperspectral images representing the state of the working process. Based thereon, a neural network, in particular a deep neural network or a deep convolutional neural network, may be trained to link every possible control action to a state of the working process and to classify the control actions with regard to the extent that they contribute to an optimal state of the working process. After completion of the method, the neural network is able to optimize the working process in each state via a corresponding control action and to keep it in the optimized state.

The neural network may be adaptable to a changed laser working process by so-called transfer learning based on training data. The training data may include: a plurality of hyperspectral images of the changed laser working process for determining corresponding input tensors, and predetermined output tensors associated with the respective hyperspectral images which contain corresponding predetermined information about the changed laser working process.

As an alternative to using a neural network, significant spectral bands may be selected from the hyperspectral image in the form of individual images and their intensity distribution may then be evaluated. In this way, for example, the geometric dimensions of a keyhole and/or a melt pool may be evaluated. The evaluated geometric dimensions may be compared with those of “good” or “bad” working processes, in particular good or bad welding processes. The deviations in the geometric dimensions may be used for identification and classification.

The laser working system may further include at least one imaging optics for imaging radiation emanating from the region of the workpiece onto the at least one hyperspectral sensor. The at least one imaging optics may be arranged in a beam path of the laser beam and/or in front of the hyperspectral sensor in the propagation direction of the radiation emanating from the region of the workpiece, for example between a beam splitter and the at least one hyperspectral sensor.

The method described above may be performed during the laser working process. In this case, the working result may be a current working result. In particular, the working result may be determined in real time or the method may be carried out after the laser working process has been completed. In this case, the output tensor may contain information about a working error. Pre-process, in-process and/or post-process monitoring may be carried out with the method described depending on whether the captured hyperspectral image contains a workpiece region in advance of the laser beam, in the current working region and/or trailing the laser beam.

### BRIEF DESCRIPTION OF THE DRAWINGS

The invention is described in detail below with reference to figures. In the figures:

FIG. 1A shows a schematic diagram of a hyperspectral sensor according to embodiments of the present disclosure;

FIG. 1B shows a schematic diagram of a hyperspectral image captured by a hyperspectral sensor according to embodiments of the present disclosure;

FIG. 1C shows a schematic diagram of a portion of a workpiece and a hyperspectral image, according to embodiments of the present disclosure;

FIG. 2 shows a schematic diagram of a laser working system according to a first embodiment of the present disclosure;

FIG. 3 shows a schematic diagram of a laser working system according to a second embodiment of the present disclosure;

FIG. 4 shows a schematic diagram of a laser working system according to a third embodiment of the present disclosure; and

FIG. 5 shows a schematic diagram of a laser working system according to a fourth embodiment of the present disclosure; and

FIG. 6 shows a method for monitoring a working process on a workpiece by means of a laser beam according to an embodiment of the present disclosure.

### DETAILED DESCRIPTION OF THE DRAWINGS

Unless otherwise noted, the same reference symbols are used below for elements that are the same or have the same effect.

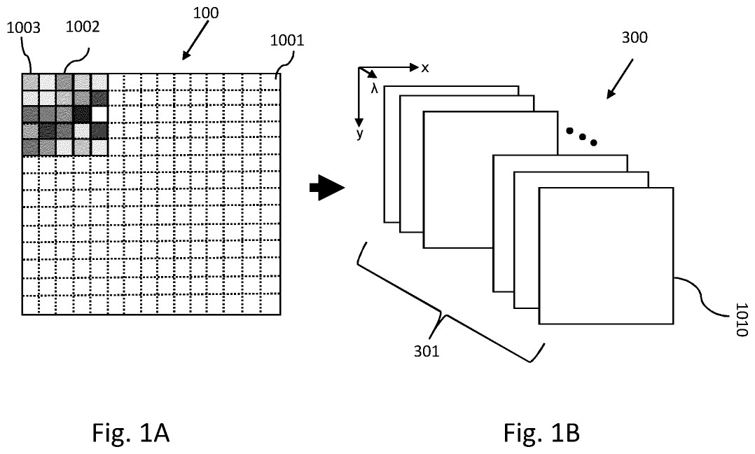

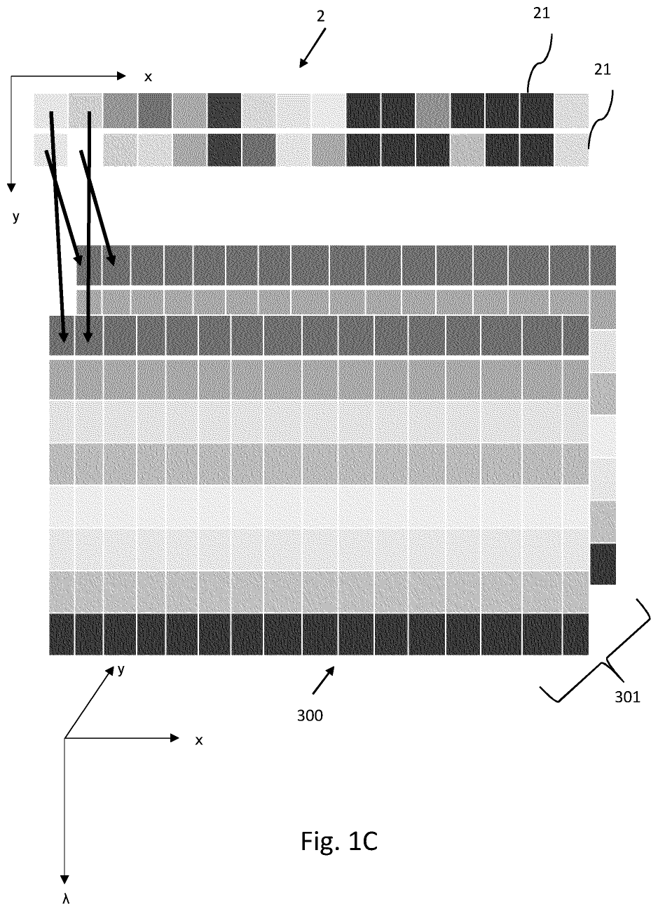

FIG. 1A shows a schematic diagram of a hyperspectral sensor according to embodiments of the present disclosure. FIG. 1B shows a schematic diagram of a hyperspectral image captured by a hyperspectral sensor according to embodiments of the present disclosure. The hyperspectral sensor shown in FIG. 1A may be combined with other embodiments of the present disclosure.

The hyperspectral sensor 100 includes a plurality of pixels 1001 arranged along a first direction (x-direction or column direction) and a second direction (y-direction or row direction) perpendicular to the first direction. The two directions correspond to two spatial dimensions of a hyperspectral image captured by hyperspectral sensor 100. All pixels 1001 of the hyperspectral sensor can detect or capture radiation within a certain wavelength range. A 5×5 optical mosaic filter 1002 is applied to the pixels 1001. The 5×5 mosaic filter 1002 includes 25 different individual filters 1003 which are arranged in a unit cell, such as a square in this case, for example. The unit cells are repeated in both directions so that an individual filter 1003 of the mosaic filter 1002 is associated with each pixel 1001 of the hyperspectral sensor. In FIG. 1A, the mosaic filter 1002 is only shown on a single patch of 5×5 contiguous pixels 1001. However, an individual filter 1003 of the mosaic filter 1002 is arranged on each pixel 1001. Each individual filter 1003 of the mosaic filter 1002 represents an optical bandpass filter and has a passband corresponding to a spectral band within the wavelength range. The 25 individual filters 1003 of the mosaic filter 1002 each have different passbands or corresponding spectral bands. The spectral bands may be contiguous and non-overlapping so that they completely cover the wavelength range.

With the aid of the hyperspectral sensor 100, radiation may be sensed or detected in a spectrally resolved manner over a large wavelength range. The radiation is filtered by the individual filters 1003 of the mosaic filter 1002 before it is sensed by the respective pixels 1001 according to the respective spectral bands. Accordingly, each pixel 1001 of the hyperspectral sensor 100 may detect or sense the intensity value of the radiation in the spectral band corresponding to the transmission range of the individual filter 1003. A bandpass-filtered intensity value can thus be associated with each pixel. This creates 25 individual images 301 having the intensity values in the spectral bands defined by the individual filters 1003.

FIG. 1C shows a schematic diagram of a region of a workpiece and a hyperspectral image according to embodiments of the present disclosure. A row-oriented hyperspectral sensor, i.e. a hyperspectral sensor with row-based bandpass filters, according to embodiments of the present disclosure includes a plurality of pixels arranged along a first direction (i.e. in the x-direction or column direction) and a second direction (i.e. in the y-direction or row direction). All pixels of the hyperspectral sensor can detect or capture radiation within a certain wavelength range. The hyperspectral sensor includes a row-based filter with L different individual optical bandpass filters. The L different optical bandpass filters are each arranged on at least one row of pixels of the hyperspectral sensor, i.e. row-oriented. In other words, the L different optical bandpass filters extend over at least one row of the sensor pixels in the first direction. Every row or every n rows, the optical bandpass filters may change in the second direction. In other words, a single optical bandpass filter covers one or more rows of pixels. Each bandpass filter has a passband that corresponds to a spectral band within the wavelength range. Accordingly, each row of the hyperspectral sensor senses an intensity of the outgoing radiation filtered by the respective bandpass filter. The different bandpass filters of the filter each have different passbands or corresponding spectral bands. The spectral bands may be contiguous and non-overlapping so that they completely cover the wavelength range.

With the aid of the hyperspectral sensor, radiation can be sensed or detected in a spectrally resolved manner over a large wavelength range. The radiation is filtered by means of the bandpass filter before it is sensed by the respective pixels according to the respective spectral bands. Accordingly, each pixel of the hyperspectral sensor may detect or sense the intensity value of the radiation in the spectral band corresponding to the transmission range of the bandpass filter. A bandpass-filtered intensity value can thus be associated with each pixel. In order to obtain a hyperspectral image of a region of the workpiece 2, the rows 21 of the workpiece area are scanned by the hyperspectral sensor in the second direction, i.e. in the y-direction or row direction. Thus, each row 21 of the region of the workpiece 2 is captured multiple times, i.e. with each of the bandpass filters of the hyperspectral sensor. In the case of the hyperspectral sensor having a row-based filter with L different bandpass filters, L bandpass-filtered individual images 301 with the intensity values in the spectral bands defined by the respective bandpass filters are created, which form the hyperspectral image. This method is also known as the “push broom” method. In particular, the method may be used in laser working systems with highly precise material feed. The scanning or the synchronization of the row readout may be carried out in the direction of the relative movement between the laser working head and the workpiece or in the direction of the material feed and may be tuned to the material feed speed. In other words, an individual image of the hyperspectral image which corresponds to a different wavelength range in each pixel row is captured at a point in time. The rows are then scanned in a different wavelength range by means of the scanning movement or the relative movement of each row.

This method makes it possible to increase the number of bandpass filters. The scanning movement or the relative movement is preferably perpendicular to the pixel rows of the hyperspectral sensor, i.e. the scanning movement or the relative movement may take place in the y-direction or row direction. Depending on the resolution of the hyperspectral sensor, more wavelength bands may be realized.

The hyperspectral sensor 100 is therefore configured to sense radiation and to output it as 25 bandpass-filtered individual images 301. The total of the 25 images is referred to as hyperspectral image 300, hyperspectral cube or hyperspectral data cube.

The hyperspectral sensor according to embodiments of the present disclosure includes pixels with a spectral sensitivity between 400 and 1800 nm. When using 5×5 mosaic filters, a hyperspectral image or a hyperspectral having 25 individual images cube can be captured. Each of the 25 individual images therefore covers a spectral band with a width of 56 nm. In other words, each individual image corresponds to the intensity distribution in a spectral band of 56 nm. In other words, the individual images are spaced apart by a distance of 56 nm in the spectral dimension.

According to other embodiments of the present disclosure of the hyperspectral sensor (not shown), the hyperspectral sensor may include a 4×4 mosaic filter with 16 individual filters. The hyperspectral sensor is thus configured to output 16 individual images as a hyperspectral image. For example, the hyperspectral sensor may include 2048×1088 pixels and be configured as a CMOS sensor. The hyperspectral sensor comprises a 4×4 mosaic filter. This reduces the positional or spatial resolution by a factor of 4. In other words, a hyperspectral image captured by such a hyperspectral sensor includes 16 individual images, each having 512×272 pixels.

Thus, the hyperspectral sensor can significantly simplify image recordings in different spectral bands and enable snapshot recordings separated into consecutive spectral bands.

The hyperspectral sensor 100 may be based on graphene or InGaAs and have a sensitivity between 400 nm and 1800 nm, for example. According to other embodiments, the hyperspectral sensor 100 may be based on InGaAs with a spectral sensitivity between 900 and 1800 nm. According to still other embodiments, the hyperspectral sensor may be a near-infrared enhanced CMOS sensor. Graphene-based hyperspectral sensors have a high consistent sensitivity between 400 and 1800 nm.

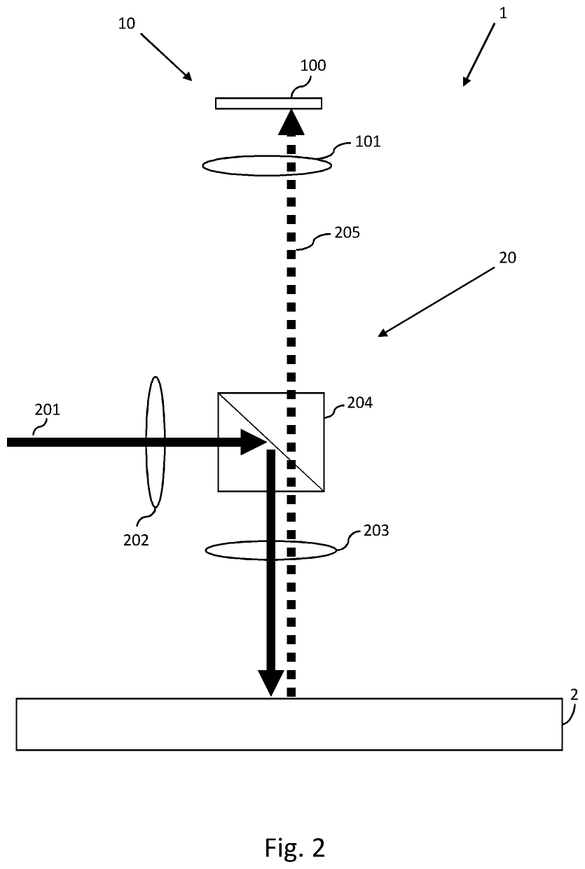

FIG. 2 shows a schematic diagram of a laser working system for performing a working process, such as welding or cutting, on a metallic workpiece using a laser beam according to a first embodiment of the present disclosure;

The laser working system 1 includes a laser working head 20 and a sensor unit 10 for monitoring the working process. The laser working head 20 may be a laser cutting, laser soldering or laser welding head.

The laser working system 1 comprises a laser device (not shown) for generating a laser beam 201 (also referred to as “working beam” or “working laser beam”).

According to embodiments, the laser working system 1 or parts thereof, such as the working head 20 for example, may be movable along a working direction. The working direction may be a cutting, soldering or welding direction and/or a direction of movement of the laser working system 1, such as the working head 20, with respect to the workpiece 2. In particular, the working direction may be a horizontal direction. The working direction may also be referred to as “feed direction”.

The laser working system 1 is controlled by a control unit (not shown) configured to control the working head 20, the sensor unit 10 and/or the laser device. The laser working system 1 may also include a computing unit (not shown) configured to determine information about the working process. According to one embodiment, the computing unit is combined with the control unit (not shown). In other words, the functionality of the computing unit may be combined with that of the control unit in a common processing unit.

The laser device 1 may include collimator optics 202 for collimating the laser beam 201 and focusing optics 203 configured to focus the laser beam 201 onto the workpiece 2. The laser device 1 may also include a beam splitter 204 configured to direct the laser beam 201 onto the workpiece 2.

Radiation 205 emanating from the workpiece 2 is produced during the working process or during the working of the workpiece 2 by means of the laser beam 201. The radiation 205 may be light of the laser beam 201 reflected or scattered back from a surface of the workpiece 2, plasma radiation, thermal radiation, or visible light. The radiation 205 may also include light from a lighting source (not shown) radiated onto the workpiece 2 and reflected back.

The sensor unit 10 comprises a hyperspectral sensor 100 and imaging optics 101. According to embodiments, the imaging optics 101 may also be omitted. The imaging optics 101 is configured to image or focus the radiation 205 onto the hyperspectral sensor 100.

According to the embodiment shown in FIG. 2, the sensor unit 10 comprises a hyperspectral sensor 100 with a spectral sensitivity of 400 nm to 1800 nm. According to other embodiments, the sensor unit 10 comprises a hyperspectral sensor with a spectral sensitivity of 400 to 950 nm or up to 1000 nm. According to embodiments the hyperspectral sensor 100 may be a graphene- or InGaAs-based mosaic filter hyperspectral sensor as described with reference to FIGS. 1A and 1B. According to other embodiments, the hyperspectral sensor 100 may be a near-infrared enhanced mosaic filter hyperspectral sensor as described with reference to FIGS. 1A and 1B.

The sensor unit 10 or the hyperspectral sensor 100 is configured to sense the radiation 205 emanating from the workpiece 2 and to output it as a hyperspectral image. The computing unit is configured to determine information about the working process, in particular information about a working result, for example a working error, based on the hyperspectral image. The determination may be made by means of deep neural networks, in particular deep convolutional neural networks.

According to the embodiment shown in FIG. 2, the sensor unit 10 is attached or coupled to the laser working head 20.

According to the embodiment shown in FIG. 2, the sensor unit 10 is arranged such that the radiation 205 emanating from the workpiece is guided to the sensor unit 10 coaxially with the laser beam 201 in the laser working head 20. The radiation 205 emanating from the workpiece thus enters the laser working head 20 counter to the propagation direction of the laser beam 201 and is incident on the sensor unit 10. The radiation 205 passes through the focusing optics 203 and the beam splitter 204 before it is incident on the sensor unit 10. In other words, the radiation 205 and the laser beam 201 overlap in the laser working head 20.

The laser working system may also include a computing unit that determines a multi-channel input tensor based on the hyperspectral image captured by the sensor unit and an output tensor based on the input tensor using a transfer function containing information about the working process. The transfer function may be formed by a neural network, preferably by a deep neural network or a deep convolutional neural network. Based on the output tensor, the computing unit outputs regulation data or control data to the control unit of the laser working system. Anomaly detection may be carried out on the basis of the hyperspectral images or cubes by using the hyperspectral images of error-free processes as a database. Anomaly detection may be performed using standard techniques, building a model from the training data, and computing the deviation of the features from the model in the inference.

The classification into typical error classes, such as gap, offset, lack of penetration and welding, ejection and pore formation, requires the generation of a large number of training data containing these typical errors. This means weldings must be carried out for each type of error. The training data generated in this way consist of the hyperspectral images and the added error descriptions. These training data sets may be used to apply a supervised machine learning method for classification. For example, the generated hyperspectral images may be used as multi-channel input tensors for a deep neural network, typically a convolutional neural network. In the inference, the generalized transfer function generated after the training process maps the hyperspectral images to the output vector, which provides the prediction of the error classification. The learned generalized transfer function formed from the model of the deep convolutional neural network contains feature vectors describing the process in the last fully connected layers.

Considering the hyperspectral cube as a multi-channel input tensor of a deep neural network, in particular a deep convolutional neural network, facilitates the training of such networks and the associated formation of a generalized mapping function that maps the input tensor to a classification result. The use of the hyperspectral image to map the process can be applied in a “reinforcement deep Q learning” method: The hyperspectral image, considered as the status of the process, facilitates learning the benefit of an action regarding the process using a deep convolutional neural network. After learning is complete, the program is able to perform the optimal modification of the process for each state.

The optimization of the laser welding process using a reinforcement learning method is facilitated by evaluating the actions regarding the process, e.g. a change in laser power or a change in welding speed. The actions resulting in an optimal process are highly valued. Since there is expert knowledge about the laser process, the number of actions regarding the process can be restricted. A deep neural network, typically a convolutional neural network, may thus be used over a large number of welding tests in order to train the association of the status, represented by the hyperspectral cube, with the evaluation for each possible or permitted action. The trained network then allows the optimal action regarding the process to be taken from any state in order to optimize the process and keep it in an optimal state.

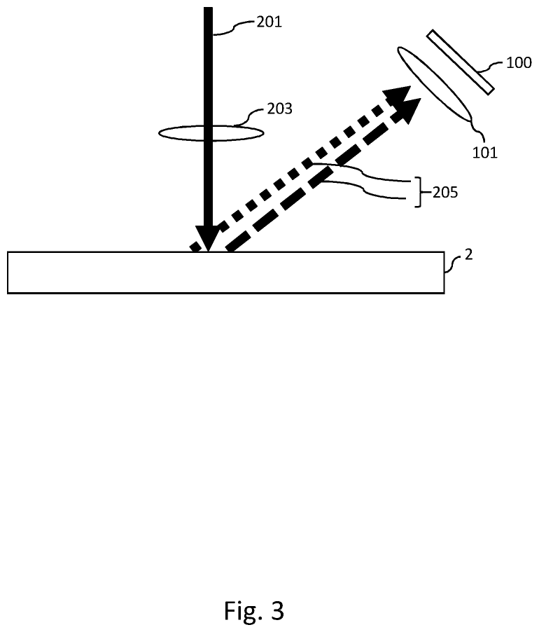

FIG. 3 shows a schematic diagram of a laser working system according to a second embodiment of the present disclosure. The laser working system shown in FIG. 3 corresponds to the laser working system shown in FIG. 2 except for the differences described below.

According to the embodiment shown in FIG. 3, the beam path of the radiation 205 which emanates from the workpiece region and is guided to the sensor unit 10 extends outside of the laser working head 20. The radiation 205 therefore does not enter the laser working head 20 before it is incident on the sensor unit 10. In other words, the radiation 205 and the laser beam 201 do not overlap in the laser working head 20. Any filter effects of the focusing optics of the laser working head 20 are omitted.

According to the embodiment shown in FIG. 3, the sensor unit 10 may be attached to a side surface of the laser working head. This arrangement of the sensor unit is also referred to as an “off-axial arrangement”.

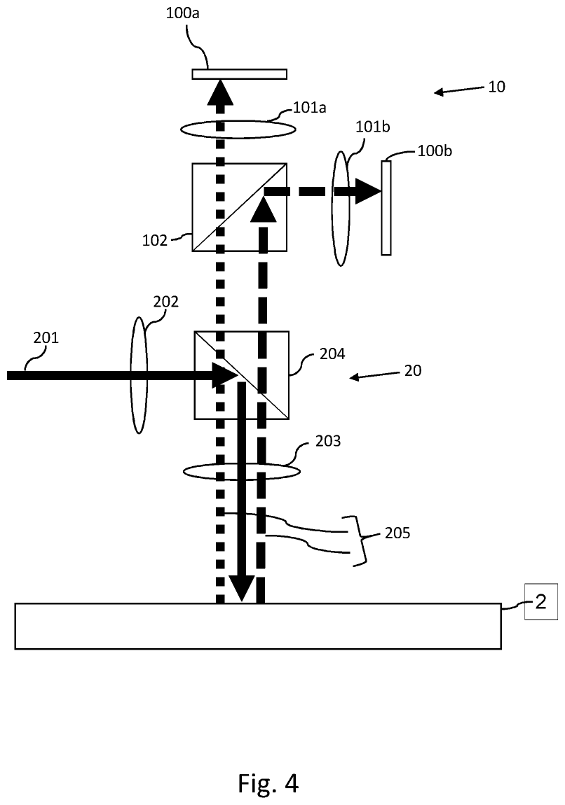

FIG. 4 shows a schematic diagram of a laser working system according to a third embodiment of the present disclosure. The laser working system shown in FIG. 4 corresponds to the laser working system shown in FIG. 2 except for the differences described below.

The sensor device 10 comprises a first hyperspectral sensor 100a, a second hyperspectral sensor 100b and a beam splitter 102. Instead of a sensor with broadband sensitivity, as in the exemplary embodiments of FIGS. 2 and 3, a corresponding wavelength range is covered by means of two hyperspectral sensors 100a and 100b and a beam splitter 102 in this embodiment. The hyperspectral cubes of the individual hyperspectral sensors, for example an InGaAs image sensor and an NIR-enhanced CMOS image sensor, may be combined to form a hyperspectral cube.

The beam splitter 102 is configured to split the radiation 205 emanating from the workpiece and direct it onto the first hyperspectral sensor 100a and the second hyperspectral sensor 100b. The sensor device 10 may further comprise first imaging optics 101a and second imaging optics 101b respectively arranged in front of the first and second hyperspectral sensors 100a and 100b in order to image the part of the radiation 205 thereon.

According to the embodiment shown in FIG. 4, the first hyperspectral sensor 100a has a spectral sensitivity from 400 nm to 950 nm or from 400 nm to 1000 nm and the second hyperspectral sensor 100b has a spectral sensitivity from 1000 nm to 1700 nm or from 900 to 1800 nm. According to embodiments, the first hyperspectral sensor 100a may be a near-infrared enhanced CMOS sensor with mosaic filter as described with reference to FIGS. 1A and 1B. Likewise, the second hyperspectral sensor 100b may be an InGaAs-based hyperspectral sensor with a mosaic filter as described with reference to FIGS. 1A and 1B.

The sensor unit 10 according to FIG. 4 is configured to combine and output the hyperspectral images captured by the first hyperspectral sensor 100a and the second hyperspectral sensor 100b to form a single hyperspectral image. In this case, the combined hyperspectral image may comprise 50 individual images. The first hyperspectral sensor 100a and the second hyperspectral sensor 100b may have different resolutions, i.e. a different number of pixels. The sensor unit 10 may therefore be configured to adapt the resolutions of the respective hyperspectral images obtained from the two hyperspectral sensors to one another so that the individual images in the hyperspectral cube have the same spatial dimension.

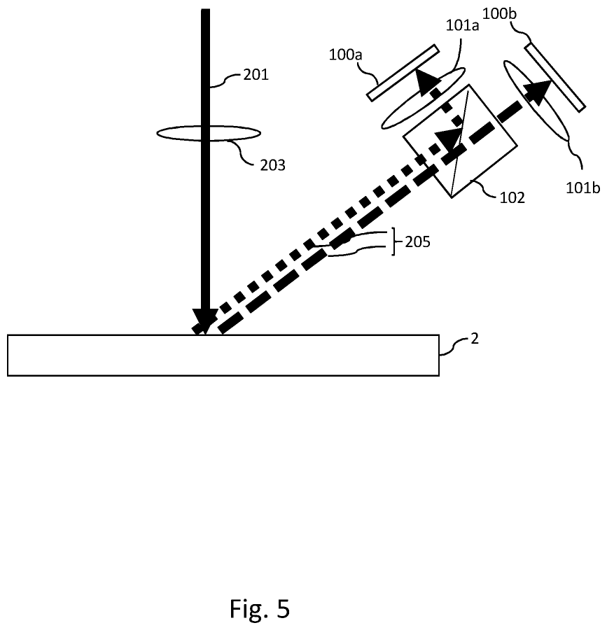

FIG. 5 shows a schematic diagram of a laser working system according to a fourth embodiment of the present disclosure. The laser working system shown in FIG. 5 corresponds to the laser working system shown in FIG. 4 except for the differences described below.

According to the embodiment shown in FIG. 5, the beam path of the radiation 205 that emanates from the workpiece region and is guided to the sensor unit 10 extends outside of the laser working head 20. The radiation 205 therefore does not enter the laser working head 20 before it is incident on the sensor unit 10. In other words, the radiation 205 and the laser beam 201 do not overlap in the laser working head 20.

According to the embodiment shown in FIG. 5, the sensor unit 10 may be attached to a side surface of the laser working head. This arrangement of the sensor unit is also referred to as an “off-axial arrangement”.

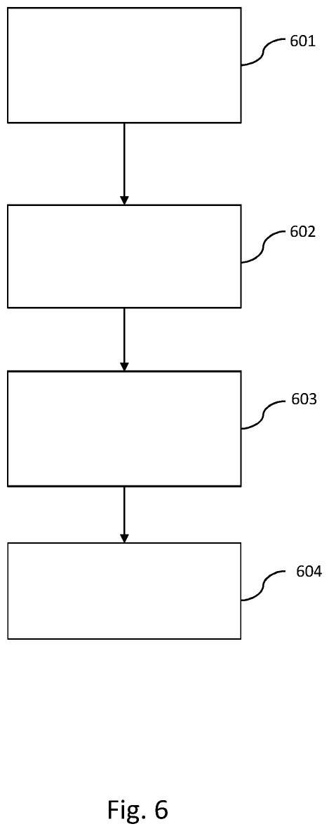

FIG. 6 shows a method for monitoring a working process on a workpiece using a laser beam.

The method may be performed by a laser working system according to embodiments of the present disclosure.

The first step 601 includes radiating a laser beam into a working region on a workpiece. In a second step 602, a hyperspectral image of a region of the workpiece with N times M pixels is acquired. Each pixel comprises L values, wherein the hyperspectral image has two spatial dimensions x and y and one spectral dimension λ, and wherein N indicates a number of pixels in the first spatial dimension x, M indicates a number of pixels in the second spatial dimension y, and L indicates the number of spectral bands in the spectral dimension λ, of the hyperspectral image, where M, N and L are natural numbers.

The method may further include a third step 603, in which an input tensor is determined based on the hyperspectral image, and the method may include a fourth step 604, in which an output tensor containing information about a working result of a laser working process is determined based on the input tensor and by means of a transfer function. The transfer function between the input tensor and the output tensor may be formed by a trained neural network.

According to an embodiment, steps 602 to 604 are carried out in parallel or at the same time as step 601. According to another embodiment, steps 602 to 604 are carried out after the end of step 601.

According to embodiments of the disclosure, in a laser working process, in which a laser beam is radiated onto a working region of the workpiece, a hyperspectral image of a region of the workpiece is captured to monitor the laser working process. The captured region may include the working region and/or regions in advance of or trailing the laser beam. The hyperspectral image includes N times M pixels in two spatial dimensions. Each pixel has L values in a spectral dimension. In other words, the hyperspectral image includes L individual images with N times M pixels. L indicates the number of spectral bands in a detected wavelength range. The L spectral bands may be adjacent to each other. A hyperspectral image or cube over the entire wavelength range of the radiation emitted by the working process completely maps the process since all wavelengths are spatially resolved. The hyperspectral image contains extensive information about a state of the laser working process and can therefore be used as a basis for monitoring and controlling the laser working process. In addition, information about a working result of the laser working process which includes information about a working error may be obtained using the hyperspectral image. The state of the laser working process or the information about a working result may be determined using a (deep) neural network, with the captured hyperspectral image being used as the basis for the input tensor of the deep neural network.

1. A laser working system for carrying out a working process on a workpiece by a laser beam, said laser working system comprising:
a laser working head for radiating a laser beam into a working region on said workpiece; and
a sensor unit for monitoring said working process with at least one hyperspectral sensor, said sensor unit being configured to capture a hyperspectral image with N times M pixels of a region of said workpiece, each pixel comprising L values,
wherein the hyperspectral image has two spatial dimensions x and y and one spectral dimension λ, and wherein N denotes a number of pixels in the first spatial dimension x, M denotes a number of pixels in the second spatial dimension y, and L denotes the number of spectral bands in the spectral dimension λ of the hyperspectral image, where M, N and L are natural numbers greater than zero.

2. The laser working system according to claim 1, wherein said sensor unit is configured to sense radiation emitted by the captured region of said workpiece and/or reflected laser radiation and to output it as a hyperspectral image.

3. The laser working system according to claim 1, wherein said sensor unit is configured to sense at least one of the following types of radiation: thermal radiation, radiation in the infrared range of light, radiation in the near-infrared range of light, radiation in the visible range of light, plasma radiation, reflected light of the laser beam, backscattered light of the laser beam, and light that is radiated by a lighting source and reflected.

4. The laser working system according to claim 1, wherein the region of said workpiece captured in the hyperspectral image comprises at least one of the following regions on the workpiece: the working region, a region in the advance of said laser beam, a region trailing said laser beam, an region still to be machine worked and a machine worked region.

5. The laser working system according to claim 1, wherein L is equal to or greater than 16, preferably equal to or greater than 20, preferably equal to or greater than 25, or preferably equal to or greater than 100.

6. The laser working system according to claim 1, wherein the spectral bands are of the same size and/or adjacent and/or consecutive.

7. The laser working system according to claim 1, wherein said sensor unit is configured to capture hyperspectral images continuously and/or to capture one hyperspectral image per predetermined time interval.

8. The laser working system according to claim 1, wherein said sensor unit is configured to sense all L values for all of the N times M pixels of the hyperspectral image simultaneously, or wherein said sensor unit is configured to sense all pixel rows of the hyperspectral image simultaneously but in different spectral bands and the L values of the different spectral bands for each pixel row or for all n pixel rows sequentially.

9. The laser working system according to claim 1, wherein said hyperspectral sensor comprises a mosaic filter having N times M individual filters with L different transmission ranges or wherein said hyperspectral sensor comprises a plurality of pixel rows and the pixels are arranged in a pixel row in a first direction (x) and said hyperspectral sensor comprises a row filter, in which an individual filter of a plurality of individual filters extends over at least one pixel row of said hyperspectral sensor and said plurality of individual filters with L different transmission ranges are arranged in a second direction (y) perpendicular to the first direction (x).

10. The laser working system according to claim 1, wherein the at least one hyperspectral sensor has a spectral sensitivity range from 400 nm to 1800 nm, and/or from 400 nm to 950 nm, and/or from 400 nm to 1000 nm, and/or from 1000 nm to 1700 nm, and/or from 950 nm to 1800 nm, and/or from 1200 nm to 2000 nm.

11. The laser working system according to claim 1, wherein the at least one hyperspectral sensor comprises a CMOS camera, an infrared-enhanced CMOS sensor, a near-infrared (NIR) enhanced CMOS sensor, an InGaAs-based sensor, a graphene-based sensor, a sensor array and/or a diode array.

12. The laser working system according to claim 1, further comprising:
a computing unit configured to determine an input tensor based on the hyperspectral image and to determine an output tensor based on the input tensor using a transfer function containing information about said working process;
wherein the transfer function between the input tensor and the output tensor is formed by a deep neural network, in particular by a deep convolutional neural network.

13. The laser working system according to claim 12, wherein said computing unit is configured to form the output tensor in real time and, based thereon, to output control data to a control unit of said laser working system.

14. The laser working system according to claim 12, wherein the output tensor contains one of the following information: information about a state of the working process, information about a working error, the presence of at least one working error, a type of working error, a position of the working error on the workpiece, a probability of a working error of a certain type and spatial and/or areal extent of the working error.

15. A method for monitoring a working process on a workpiece by a laser beam, said method comprising the steps of:
radiating a laser beam into a working region on a workpiece; and
acquiring a hyperspectral image with N by M pixels of a region of said workpiece, each pixel comprising L values,
wherein the hyperspectral image has two spatial dimensions x and y and a spectral dimension λ and wherein N indicates a number of pixels in the first spatial dimension x, M indicates a number of pixels in the second spatial dimension y, and L indicates the number of spectral bands in the spectral dimension λ of the hyperspectral image, where M, N and L are natural numbers.

16. The method according to claim 15, further comprising the steps of:
determining, based on the hyperspectral image, an input tensor; and
determining, based on the input tensor and by means of a transfer function, an output tensor containing information about said working process,
wherein the transfer function between the input tensor and the output tensor is formed by a deep neural network, in particular by a deep convolutional neural network.
